(19) United States
(12) Patent Application Publication
(10) Pub. No.: US 2003/0140665 A1
(43) Pub. Date: Jul. 31, 2003

(54) Multi-bolt security door

(76) Inventors: Dale M. Szuminski, Alpine, UT (US); Richard E. Stepp, Provo, UT (US)

Correspondence Address: Joshua S. Broitman, Ostrager Chong & Flaherty LLP, 825 Third Avenue, New York, NY, 10022-7519, US

(21) Appl. No.: 10/352,707

(22) Filed: Jan. 28, 2003

Related U.S. Application Data
(60) Provisional application No. 60/352,441, filed on Jan. 28, 2002.

(51) Int. Cl. E05B 47/06

(52) U.S. Cl. 70/257; 70/283

(57) ABSTRACT

A security door having improved security features. The door has a retractable, multiple pin deadbolt bar that can be operated by an inner or outer door handle. The inner door handle has shaft with an external screw thread that allows the handle assembly to be attached to and supported by a stabilizer mounted on the door. The door is attached to a door frame with internally mounted hinges that provide 180° rotation in only one direction such that the door may be opened to rest against the wall to which it is attached but may not be pushed in. A security bar is attached to door side panel where the hinges are located to prevent the door from being pulled out if the hinges broken. The door's lock may be controlled by a remote keypad or wireless device.

### PRIORITY CLAIM

This application claims priority from U.S. Provisional Patent Application No. 60/352,441 filed on Jan. 28, 2002.

### FIELD OF INVENTION

This invention generally relates to a security door having improved security features, and more particularly to a security door comprising a remote-activated, multiple dead-bolt locking assembly that may be used in a wide variety of applications.

### BACKGROUND OF INVENTION

Doors having enhanced security features, such as multiple locking bolts or pins that simultaneously project from or retract into the door, are well known and have been developed for many specific applications. For example, U.S. Pat. No. 1,094,962 to Arens discloses a hollow metal fire door, U.S. Pat. No. 393,883 to Brown discloses a safe or vault door, and U.S. Pat. No. 992,296 to Titterton discloses spring-actuated locking mechanism for safes or strong rooms. Such security doors utilize complicated configurations of camming grooves, pin followers and pivotally linked bars to simultaneously move the multiple bolts. See, e.g., U.S. Pat. No. 5,111,674 to Huang, U.S. Pat. No. 5,096,238 to Mintz, U.S. Pat. No. 4,470,277 to Uyeda.

Remote activated locking mechanisms are also known. U.S. Pat. No. 5,490,698 to Dezso discloses a door lock including an electronic circuit comprising a solenoid operated door striker that is engagable by the door's locking bolt. When a remote switch sends a signal, the striker in the door frame moves the striker such that the door becomes unlocked and can swing open. U.S. Pat. No. 6,035,676 to Hudspeth discloses a remotely operated deadbolt lock comprising an actuator that moves in response to a remote signal, thereby providing a lateral force directly to the end of the deadbolt.

Thus, prior art devices attempt to solve the same general problem of providing a secure door with multiple deadbolts. However, each has a problem in utilization that makes it relatively unattractive to manufacture or use. For example, some devices incorporate costly locking mechanisms. Others require complicated mechanical linkages to control the multiple deadbolts that are unique to the disclosed type of door. Yet others require substantial modification to achieve the same result in different size doors for different applications. Further, none of the prior art doors include additional safety features or features that reduce manufacturing cost and ease of use. Accordingly, it is a broad object of the invention to provide a cost efficient security door that is easy to manufacture and use having multiple security features that can be readily modified to use on multiple size doors for a wide range of applications.

### SUMMARY OF INVENTION

In the present invention, the foregoing purposes, as well as others that will be apparent, are achieved generally by providing a security door comprising a retractable, multiple pin deadbolt bar having a plurality of pins wherein the deadbolt bar is mounted on an interior surface of the door. The deadbolt bar can be operated by an inner or outer door handle. The inner door handle is attached to a shaft having an external screw thread at the distal end, the external screw thread being rotatably engaged with the interior threaded surface of a stabilizer that is attached to the interior surface of the door. The door is attached to the door frame with internally mounted hinges that provide 180° rotation in only one direction, such that the security door may be opened to rest against the wall to which it is attached but may not be pushed in. Further, a security bar is attached to door side panel where the hinges are located to prevent the door from being pulled open even if the hinges have been destroyed or broken.

In a preferred embodiment, the multiple pin deadbolt bar is mechanically connected to the inner and outer handles through a series of metal plates having pins and slots that provide the required pivoting and sliding actions for extending and retracting the deadbolt bar. A tongue/groove lock may be used to perform the locking features of the invention, i.e., preventing the pins from being retracted into the door until the locking assembly or lock is unlocked. The lock may be controlled by keys, dials, wireless controls (e.g. infra-red or radio frequency), keypads, remote keypads and such other means suitable for directly or remotely controlling the lock. In a preferred embodiment, the security door employs a remote keypad operated lock. Other objects, features and advantages of the present invention will become apparent when the detailed description of the preferred embodiments of the invention are considered in conjunction with the drawings which should be construed in an illustrative and not limiting sense as follows.

### BRIEF DESCRIPTION OF DRAWINGS

FIG. 1 is a front (i.e. outside or exterior) view of a security door embodying features of the present invention.

FIG. 2 is a cross-sectional top view of the security door taken along the line 2-2 in FIG. 1 showing a pin of the multiple pin lock structure in a locked position.

FIG. 3 is a cross-sectional top view of the security door taken along the line 3-3 in FIG. 1 showing a hinge in a closed position.

FIG. 4 is a back (i.e. inside or interior) view of the locking assembly of a security door embodying features of the present invention.

FIG. 5 is a cross-sectional side view of the locking assembly taken along the line 5-5 in FIG. 4.

FIG. 6 is a perspective view of a multiple pin deadbolt structure for use in a security door embodying features of the present invention.

FIG. 7 is a cross-sectional top view of the locking assembly taken along the line 7-7 in FIG. 4.

FIG. 8 is a back (i.e. inside or interior) view of the locking assembly of the security showing how the security door is unlocked and opened.

FIG. 9 is a cross-sectional top view of the security door taken along the line 2-2 in FIG. 1 showing a pin of the multiple pin deadbolt structure in an unlocked position and illustrating, in phantom outline, the position of the door when swung open.

FIGS. 10 and 11 are back (i.e. inside or interior) views of the security door showing how the security door is unlocked and opened.

FIG. 12 is a partial elevation view showing the security door in an open position and a door hinge for use with the security door.

FIG. 13 is an elevation view of the security door in an open position.

FIG. 14 is a cross-sectional top view of the door hinge of the security door taken along the line 14-14 in FIG. 13

FIG. 15 is a back (or inside) view of another embodiment of the security door having two interior handles for unlocking and opening the door.

### DESCRIPTION OF PREFERRED EMBODIMENTS

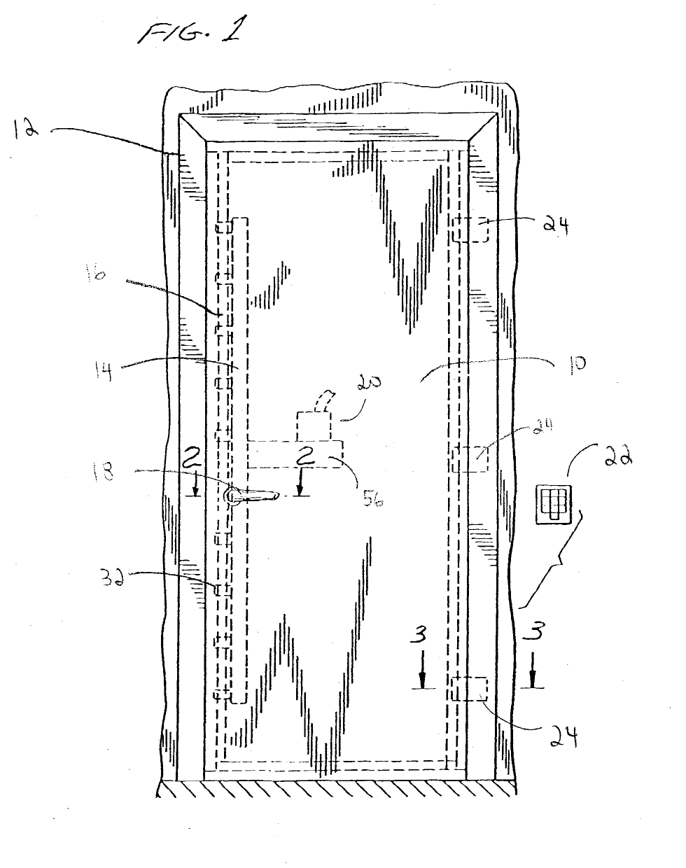

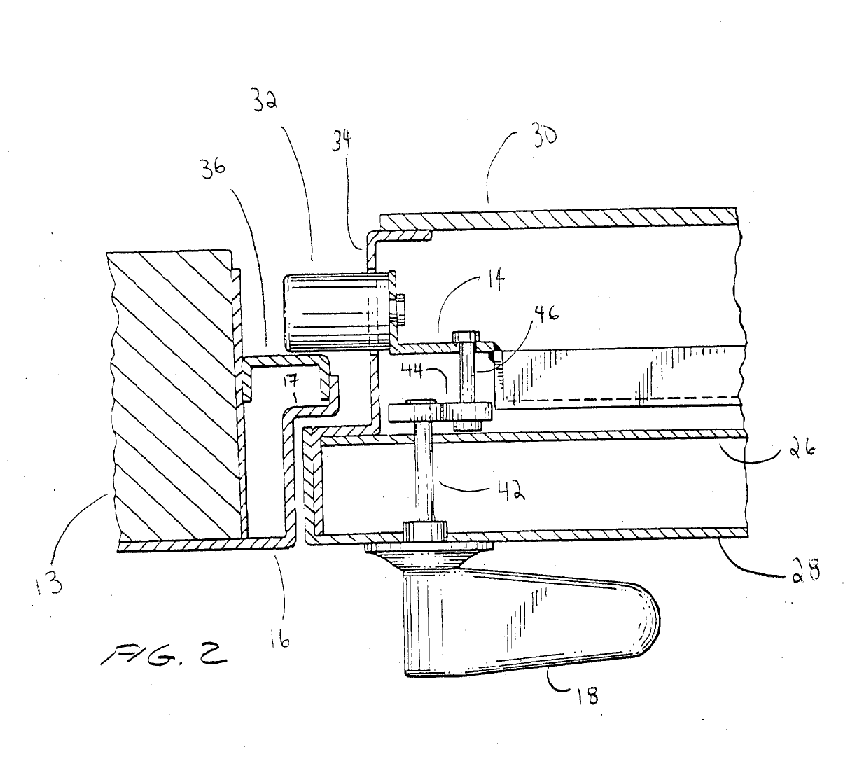

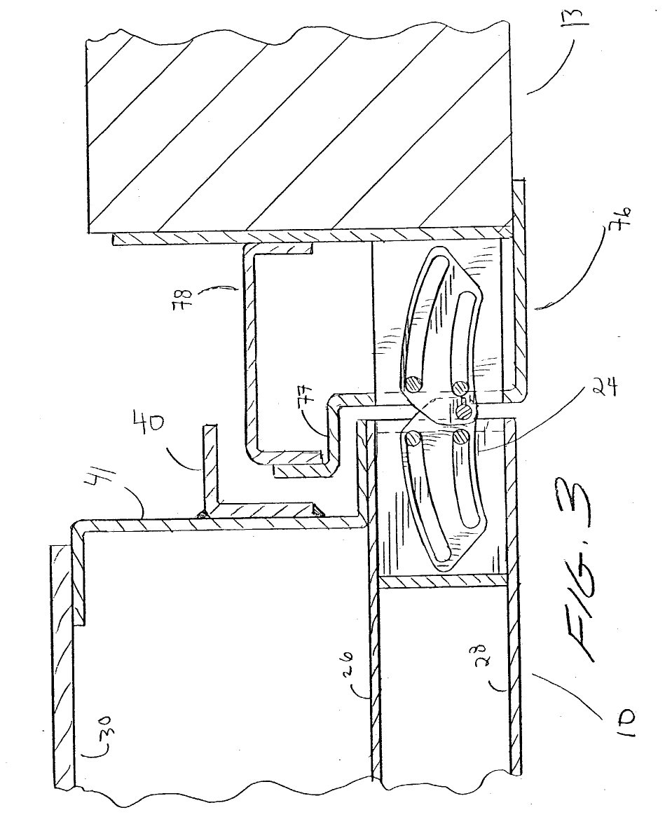

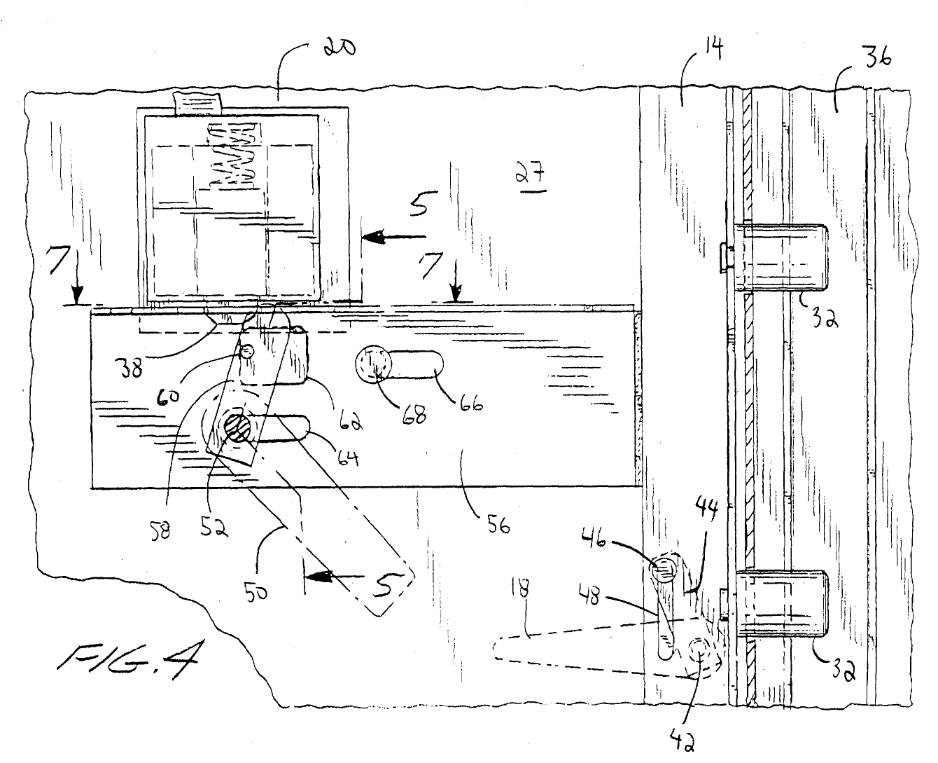

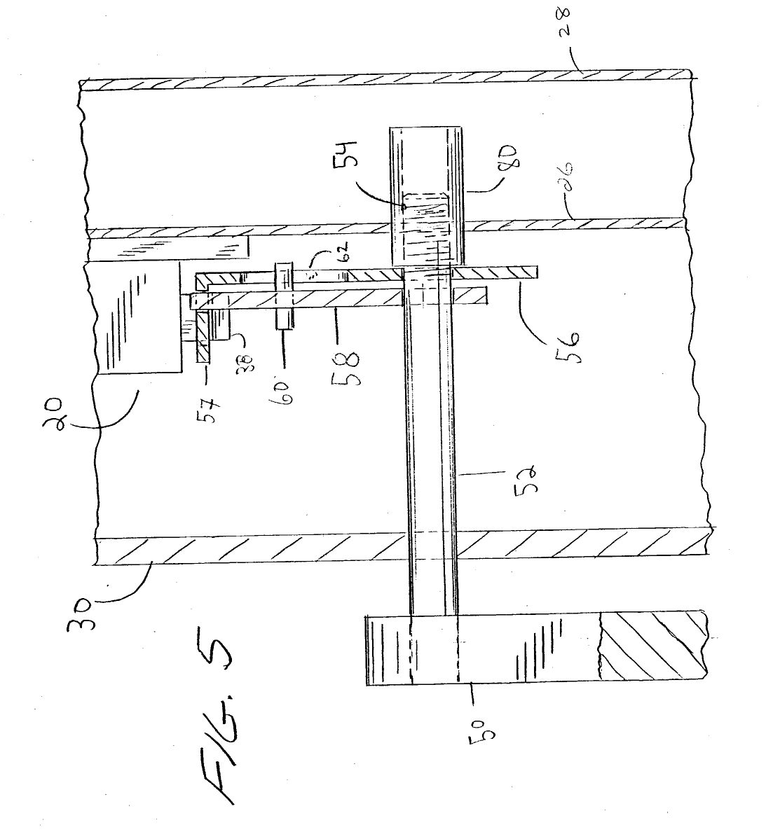

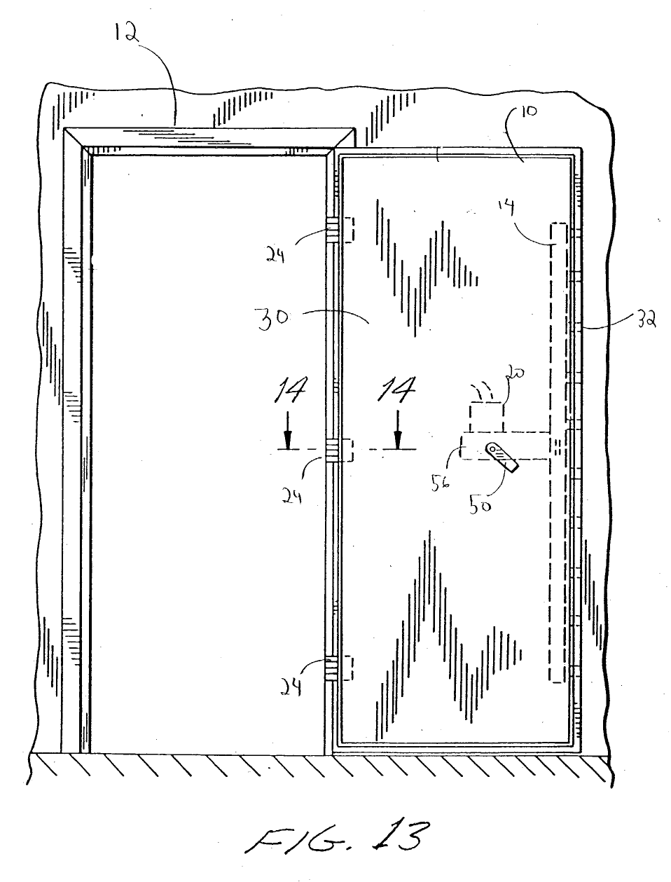

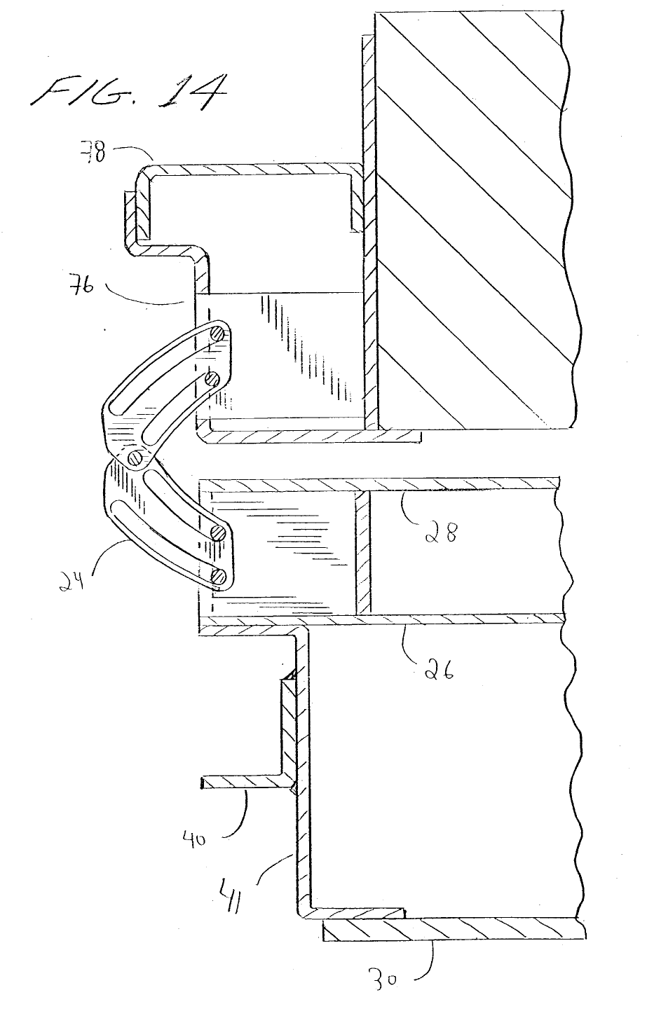

An improved security door 10 and door frame 12 are generally shown in FIG. 1 from the outside in a closed position. The door 10 generally comprises a retractable deadbolt bar 14 having a plurality of pins 32. Referring to FIGS. 2 and 3, the frame 12 generally comprises a top (not shown), a casing 13, an L-shaped portion 16 and a hinge-mounting portion 76. An L-shaped portion recessed flange 17 and a hinge portion recessed flange 77 prevent the door from being pushed inwards. The door 10 can be locked by extending the deadbolt bar 14 so that the pins 32 extend over the inner (i.e. inside) surface 36 of the L-shaped portion 16 of the frame to prevent the door from opening. See FIG. 2. The deadbolt bar 14 may be controlled by either an inner handle 50 (see FIG. 13) or an outer handle 18. The inner handle 50 is rotatably attached to and supported by a stabilizer 80 that is mounted on the door. See FIG. 5. The deadbolt bar is locked in position by a lock 20 having a retractable tongue 38 (see FIG. 4) that releasably engages the deadbolt bar, i.e., when the tongue is extended it prevents movement of the deadbolt bar and when retracted it allows movement of the deadbolt bar. Movement of the tongue 38 may be controlled mechanically or electronically, as described below. A keypad 22 is provided (see FIG. 1) to unlock the door (or retract the tongue) from a remote location, and to permit use of the outer handle 18 only upon entry of a personalized code. The remote keypad 22 may be electrically connected to the lock or may send a wireless signal to the lock. The door 10 is attached to the hinge-mounting portion 76 of the door frame by internally mounted hinges 24. The hinges 24 provide a 180° rotation in only one direction, such that the security door may be opened to rest against the wall to which it is attached (see FIGS. 12 and 13), but may not be pushed in. See FIG. 3. The security door further comprises a security bar 40 (see FIG. 3) attached to the door hinge side panel 41 to prevent the door from being pulled outwards even if the hinges are broken.

Referring to FIGS. 2 and 3, the door 10 comprises an inner door pan 26 and an outer door pan 28 mounted together along their edges such that a space is formed between the door pans. The door pans may be made from any material suitable for use as a door such as wood, metal, plastic, or composites, preferably metal. The lock 20 is mounted on the outer surface 27 of the inner door pan, i.e. on the interior or inside surface of the door 10. Fire insulation may be placed in the space formed between the door pans. A skin 30 may be placed over and mounted to the outer surfaces of both the inner door pan and outer door pan for aesthetic purposes. The skin may be comprised of such materials as metal, wood, PVC, plastic or composites, depending on the desired look and feel of the door. For example, the skin over the outer door pan may comprise a pressed metal formed into any commonly used door shape and the skin over the inner door pan may comprise a piece of pressed fiberwood (e.g., Lauan) having a carpet installed thereon.

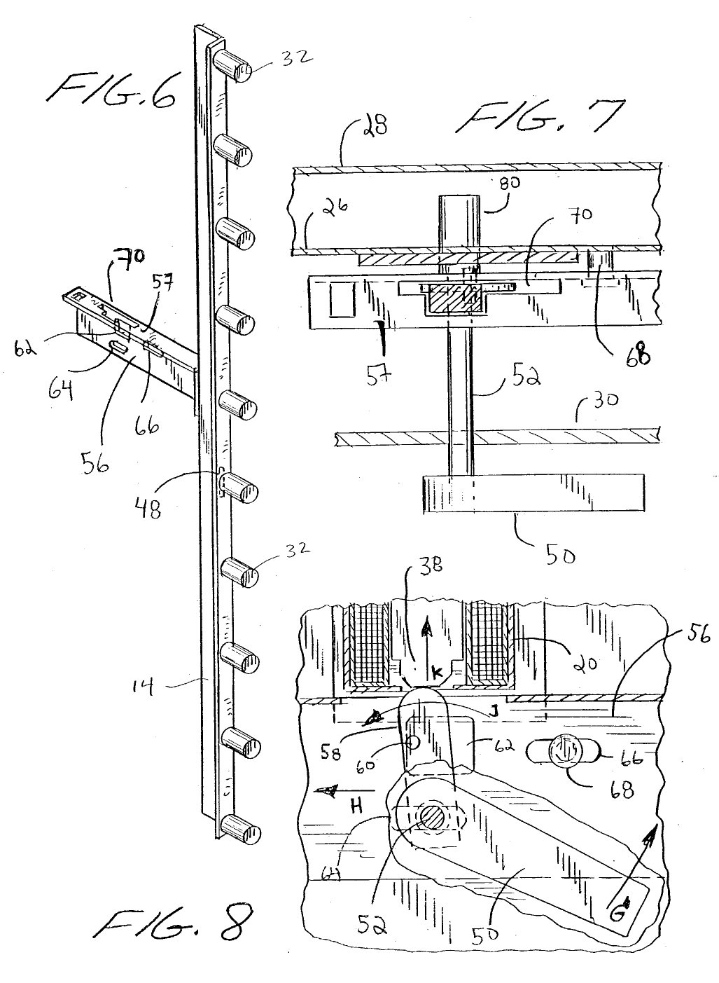

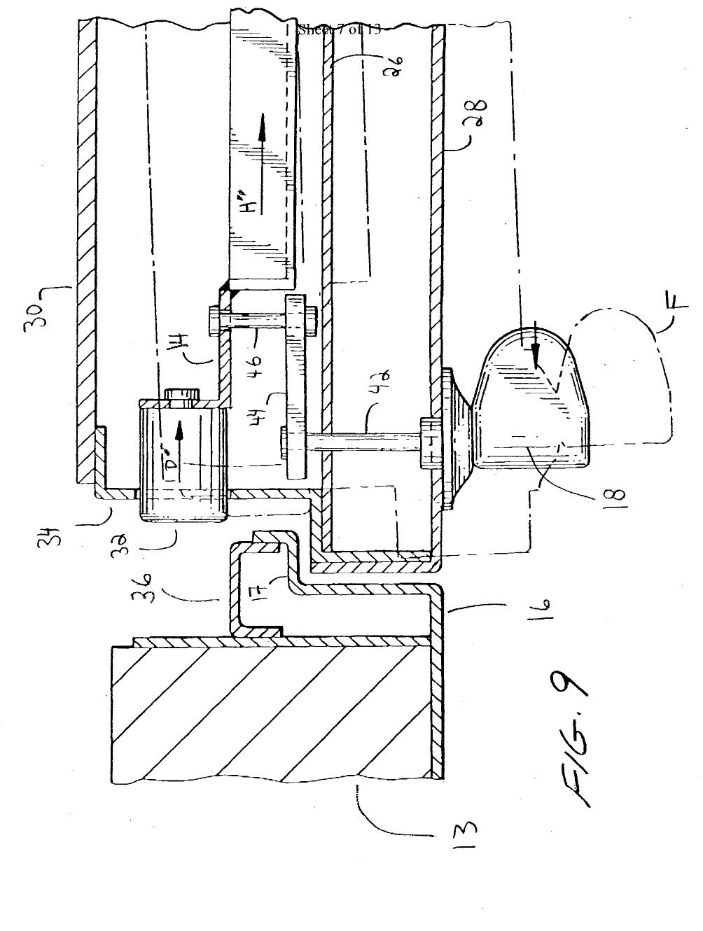

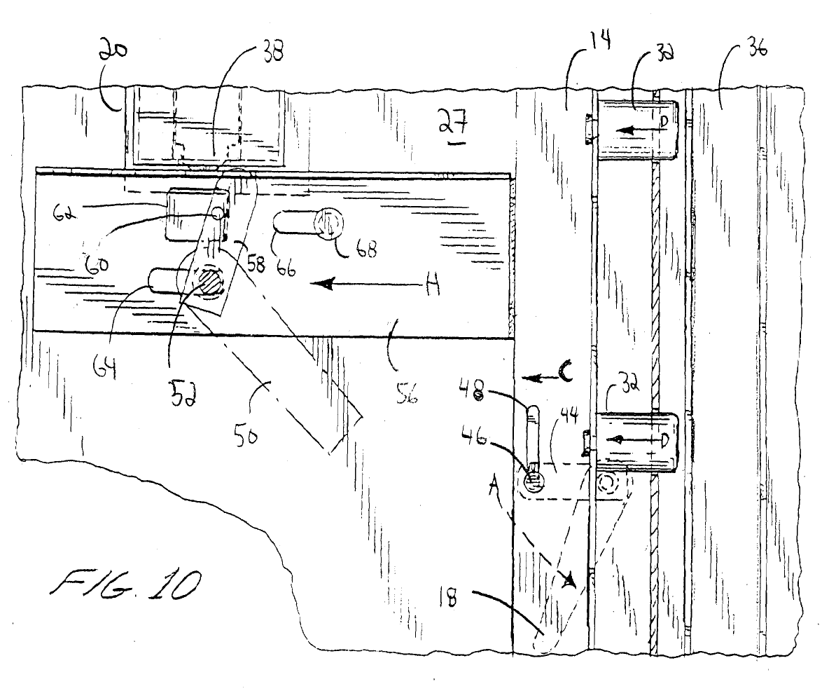

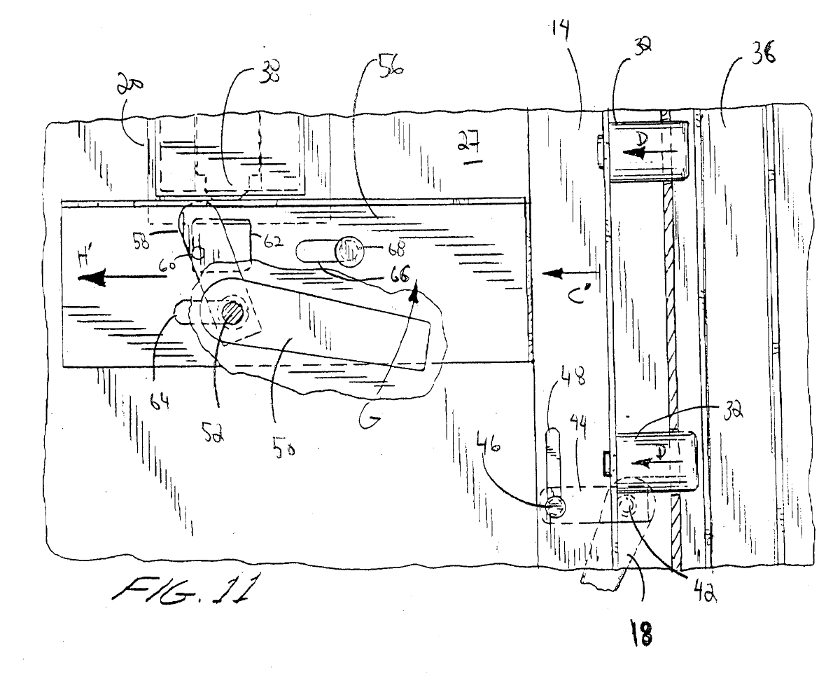

Referring to FIG. 6, the security door's deadbolt assembly comprises a plurality of pins 32. Each of the pins 32 is mounted on the deadbolt bar 14. The deadbolt assembly can be controlled by turning the door's inner handle or outer handle. The deadbolt bar 14 is positioned vertically on the outer surface 27 of the inner door pan adjacent one longitudinal side of the door (see FIGS. 1 and 13). Further, the deadbolt bar 14 is attached to the outer surface 27 of the inner door pan in horizontally slidable manner so that pins 32 extend out of the door's side panel 34 (see FIGS. 1 and 2) as the deadbolt bar slides outwards (i.e., away from the center of the door) and retract into the door's side panel 34 (see FIG. 9 and 13) as the deadbolt bar slides inwards (i.e. towards the center of the door). When extended, the pins extend over an inner frame surface 36 of the L-shaped portion 16 of the frame, thereby preventing the door from opening to the outside. See FIG. 2. The door's internal hinges 24 prevent the door from being opened to the inside. See FIG. 3. As described in more detail below, the deadbolt bar 14 is mechanically connected to the inner and outer handle assemblies through a gag plate 56 attached to the deadbolt bar 14 and a series of plates, preferably metal, having pins and slots that provide the required pivoting and sliding actions for extending and retracting the deadbolt bar. See FIGS. 4 and 10.

The outer handle assembly is shown in FIGS. 2 and 9. An outer shaft 42 is rotatably mounted on the outer door pan 28. The distal end of the outer shaft 42 extends from the outer door pan 28 through the inner door pan 26. An outer handle 18 is attached to the exterior end of the outer shaft 42 in a conventional manner. An outer plate 44 is attached to the distal end of the outer shaft 42 parallel to and above the outer surface 27 of the inner door pan. An outer pin 46 is attached to the distal end of the outer plate 44. The outer pin extends through a bar slot 48 (see FIG. 6) in the deadbolt bar 14. The locked position of the outer door assembly is shown in FIGS. 2 and 4. The unlocked position of the outer door assembly is shown in FIGS. 9 and 10.

Referring to FIGS. 4 and 10, when the outer handle 18 is turned clockwise (as viewed from the-front of the door) in the direction shown by arrow A in FIG. 10, from the locked position (see FIG. 4) to the unlocked position (see FIG. 10), the outer plate 44 rotates about the axis formed by the outer handle shaft 42 and causes the outer pin 46 to downwards. As the outer pin 46 moves downwards in an arc, it slides down the bar slot 48, thereby moving the deadbolt bar 14 horizontally to the left or inwardly, as shown by arrow C in FIG. 10. The inward movement of the deadbolt bar retracts pins 32 away from the L-shaped portion of the door frame as shown by arrows D in FIG. 10 and D′ in FIG. 9. This allows the door to be swung open in the direction of arrow E as shown in phantom outline F of FIG. 9. It should be noted that the outer door assembly is operational only when the lock 20 is in the unlocked position

The inner door handle assembly is shown in FIG. 5. An inner handle 50 is attached to one end of an inner shaft 52 in conventional manner. The other end of the inner shaft 52 has an external screw thread 54. The inner handle shaft 52 extends through a horizontal inner handle slot 64 in the gag plate 56 (see FIG. 4) and, by means of the external screw thread 54, is rotatably engaged with the interior threaded surface (not shown in FIG. 5) of a stabilizer 80 mounted on or through the inner door pan 26. Such a construction simultaneously allows easy assembly of the parts, provides additional support and stability to the gag plate 56, and allows the inner handle 50 to rotate. An inner plate 58 is attached to the inner shaft 52 in parallel relation to the inner door pan 26. The inner plate 58 is attached to the inner shaft 52 at a distance from the screw threads 54 and just above the gag plate 56. See FIG. 5. An inner pin 60 is attached to the distal end of the inner plate 58. The inner pin 60 extends into a generally rectangular inner assembly opening 62 in the gag plate 56. See FIGS. 4 and 6.

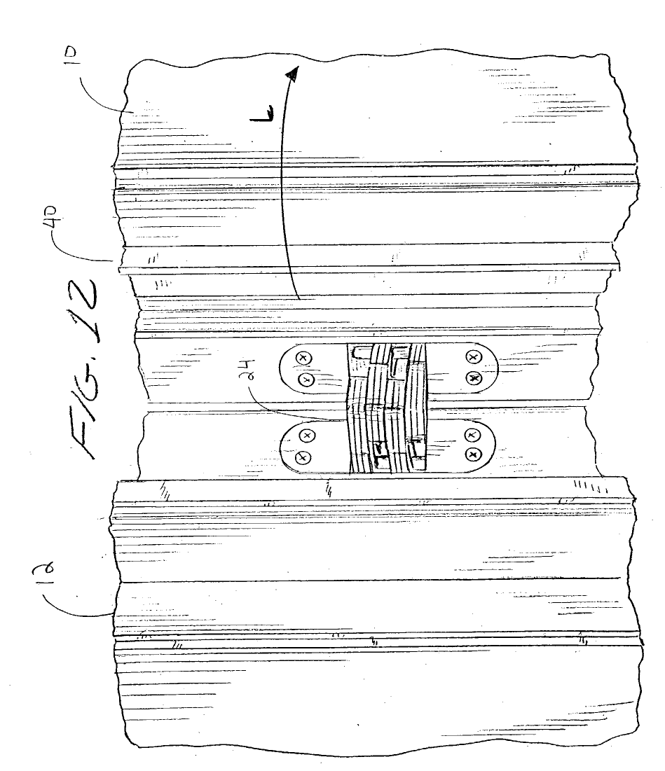

Referring to FIGS. 4 and 11, when the inner handle 50 is in the closed position (see FIG. 4), turning the inner handle counter-clockwise in the direction shown by arrow G in FIG. 11 causes the inner plate 58 to rotate about the axis formed by inner shaft 52. This, in turn, causes the inner pin 60 to move to the left or inwards, thereby moving the gag plate 56 to the left or inwards, in the direction shown by arrow H and H′ in FIGS. 10 and 11 respectively. The inward motion of the gag plate 56 moves the deadbolt bar 14 to the left or inward as show by arrow C′ in FIG. 11. The inward movement of the deadbolt bar 14 retracts the pins 32 inward, as shown by arrows D and D′ (see FIGS. 9 and 11 respectively), away from the L-shaped portion of the door frame 16. This allows the door to be swung open in the direction of arrow E as shown in phantom outline F of FIG. 9.

The inner shaft 52 extending through the inner handle slot 64 limits the inward movement and outward of the gag plate 56 thereby preventing the pins 32 from retracting too far (see FIG. 10) or extending too far (see FIG. 4). In another embodiment, a stop pin 68 is attached to the inner door pan 26. The stop pin 68 extends through a horizontal stop slot 66 in the gag plate 56. See FIG. 4. The stop pin and the stop slot coact to limit inward and outward movement of the gag plate 56 to prevent the pins 32 from retracting too far (see FIG. 10) or extending too far (see FIG. 4).

The lock of the invention is shown in FIGS. 4, 10, 11 and 15. Any commercially available tongue/groove lock may be used to perform the locking features of the invention, i.e., preventing the inward movement of the gag plate 56 until the lock is unlocked. The lock may be controlled by keys, dials, keypads, wireless controls, remote keypads and such other means suitable for directly or remotely controlling the lock. In a preferred embodiment, the security door employs a remote keypad operated lock, such as the COMPTRONIC™ 6120 Electronic Safe Lock manufactured by Sargent & Greenleaf, Inc. Referring to FIGS. 4, 10, 11 and 15, the lock 20 is shown as installed in the security door 10. The lock 20 is attached to the outer surface 27 of the inner door pan above the gag plate 56 so that the lock's retractable tongue 38 extends vertically through an aperture 70 (see FIG. 6) in the flange 57 of the gag plate 56 when the lock is in the locked position. When the tongue 38 is extended through the aperture 70, the gag plate 56 cannot be moved by the outer handle 18. See FIG. 4. The tongue 38 is retracted out of the aperture 70 by a user entering a valid code in the remote digital keypad 22. Once entered, the tongue 38 moves upwards and out of the aperture 70 (see FIG. 10) and the gag plate is operational (as described above) to retract the pins 32 inwards and away from the inner frame surface 36 of the L-shaped portion 16 of the frame (see FIGS. 10 and 11) so that the door can be opened. See FIG. 9.

Referring to FIGS. 4, 8, and 11, the door can be unlocked from the inside by turning the inner handle 50 from the closed position (see FIG. 4) in a counter-clockwise direction, as shown by arrows G and G′ (see FIGS. 11 and 8 respectively) causing the inner plate 58 to rotate about the axis formed by inner shaft 52 (as described above) as shown by arrow J in FIG. 8. This rotation of the inner plate 58, in turn, causes the distal end of the inner plate 58 to engage the tongue 38 and push it upwards, as shown by arrow K, and out of the aperture 70. See FIG. 8. As described above, this allows the inner pin 60 to move the gag plate 56 inwards to retract the pins 32 and allow the door to be opened. See FIG. 9.

Referring to FIG. 15, in another embodiment, a second inner handle assembly may be utilized as a secondary device for unlocking the lock 20. The second inner handle assembly may comprise a second inner handle 72 attached to a second inner shaft 73. The second inner shaft 73 is rotatably mounted to the outer surface 27 of the inner door pan 26, i.e. the interior or inside surface of the door. A second inner plate 74 is attached to the second inner shaft 73 in parallel relation to the inner door pan 26. Rotating the second inner handle 72 counter-clockwise causes the second inner plate 74 to rotate about the axis formed by second inner shaft 73. This causes the distal end of the second inner plate 74 to engage the tongue 38 and push it up out of the aperture (not shown) in the direction shown by arrow K′. As described above, this allows the gag plate 56 to be moved inwards to retract the pins 32 and allow the door to be opened. See FIGS. 9 to 11.

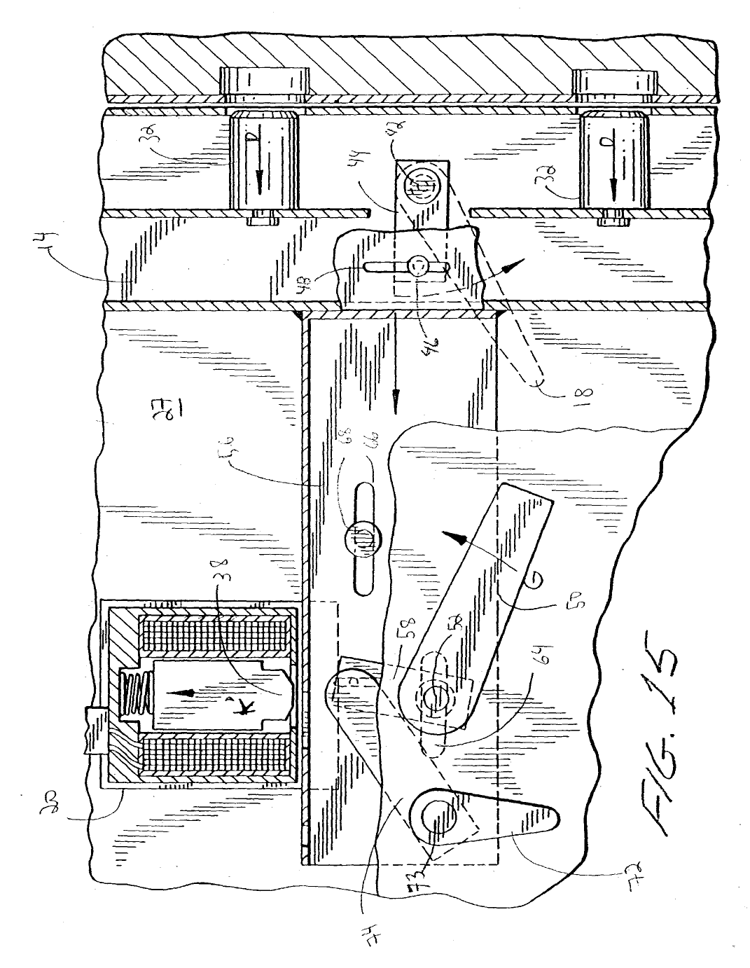

Referring to FIGS. 1, 3 and 12-14, an additional feature of the invention is the use of internal hinges 24 on the opposite longitudinal side of the door 10 for pivotally attaching the door to the frame 12. The internal hinges 24 are mounted on a peripheral edge of the door between the inner door pan 26 and outer door pan 28 to allow the door to rotate 180 degrees as shown by arrow L (see FIG. 12) such that when the door is opened, the door may lie flat against the wall (see FIG. 13) rather than sticking out as, for example, into a hallway. This feature is also advantageous because it conceals a common point of attack to deter forced entry and has more cosmetic appeal than other hinges that are mounted on an exterior surface of the door. The internal hinges suitable for use in the present invention are commercially available. One example is the SOSS® Invisible Hinge manufactured by Universal Industrial Products Company, Inc.

Referring to FIG. 3, a further feature of the invention is a security bar 40 vertically mounted along a peripheral edge of the door at the door hinge side panel 41 (i.e., along the peripheral edge of the door where the hinges are mounted) at a location that is adjacent to but at a distance from the hinges 24 so that when the door is closed the security bar 40 lies above the inner hinge-mounting surface 78 of the hinge-mounting portion 76 of the door frame. The security bar is preferably a longitudinal metal bar having an L-shaped cross-section. This feature is advantageous because it prevents the door from being pulled outwards even if the hinges 24 are destroyed or broken.

Although the invention has been described with reference to preferred embodiments, it will be appreciated by one of ordinary skill in the art that numerous modifications are possible in light of the above disclosure. For example, instead of comprising an outer and inner door pan, the door may be have a solid or unitary construction (e.g. solid wood or hollow metal) or the door pans and outer skins may be made of metal, steel, metal alloys, plastic or wood, depending on the intended use. The hinges may comprise a different configuration and have different rotational abilities depending on the desired location of the security door. Further, in the disclosed embodiment, the lock and the deadbolt assembly are mounted on the outer surface of the inner door pan (i.e. the interior or inside surface of the door) and the multiple bolts extend over an inner surface of the door's frame to prevent the door from being opened to the outside (recessed flanges in the door frame and/or the hinges prevent the door from being opened to the inside). The lock and deadbolt assembly may also be mounted entirely between the door pans and the bolts may be extended into holes in the door's frame. Also, the inner and outer door handles may be lined up to look like a normal door on both sides. Further, the security bar may be a hollow metal bar having a square or rectangular cross-section or a bar having such other shape suitable for use as security bar. All such variations and modifications are intended to be within the scope and spirit of the invention.

What is claimed is:

1. A security door comprising:
a door;
a retractable deadbolt bar having a plurality of pins, the deadbolt bar being movably mounted on an interior surface of the door adjacent to a longitudinal side of the door such that the pins may be extended past the longitudinal side to lock the door and retracted behind the longitudinal side to unlock the door;
an outer handle operatively coupled to the deadbolt bar through an outer shaft;
an inner handle operatively coupled to the deadbolt bar through an inner shaft;
a lock for releasably engaging the deadbolt bar to prevent movement of the deadbolt bar;
a control means for controlling when the lock engages the deadbolt bar and when the lock releases the deadbolt bar;
a hinge mounted on a peripheral edge of the door for connecting the door to a door frame, the hinge being rotatable 180 degrees in only one direction; and
a security bar for preventing the door from being pulled open, the security bar being mounted along the peripheral edge of the door where the binge is mounted and at a distance from the hinge such that the security bar overlaps the door frame when the door is closed.

2. The security door of claim 1, further comprising
a stabilizer for stabilizing the inner shaft, the stabilizer being mounted on the interior surface of the door.

3. The security door of claim 2, wherein the stabilizer comprises a nut having an internal screw thread and the inner shaft has an external screw thread, the external screw thread of the inner shaft being rotatably engaged to the internal screw thread of the stabilizer.

4. The security door of claim 1, wherein the control means is positioned on the outer side of the door such that the control means can be operated only from the outside of the door.

5. The security door of claim 1, wherein the control means controls the lock remotely.

6. The security door of claim 5, wherein the control means is a remote keypad.

7. The security door of claim 1, wherein the control means comprises: an outer control means positioned outside the door and an inner control means positioned inside the door such that the control means can be operated from the inside and the outside of the door.

8. The security door of claim 7, wherein the inner control means is the inner handle.

9. The security door of claim 7, wherein the inner control means comprises a second inner handle mounted on the interior surface of the door.

10. The security door of claim 7, wherein the outer control means controls the lock remotely.

11. The security door of claim 10, wherein the outer control means is a remote keypad.

12. The security door of claim 1, wherein the security bar comprises a longitudinal metal bar having an L-shaped cross-section.

13. The security door of claim 1, wherein the door comprises an inner door pan and an outer door pan.

14. The security door of claim 13, further comprising a fire insulating material disposed between the inner door pan and the outer door pan.

15. The security door of claim 13, further comprising: a first skin covering the outer surface of the outer door pan and a second skin positioned over the outer surface of the inner door pan.

16. A security door comprising:
a door;
a retractable deadbolt bar having a plurality of pins, the deadbolt bar being movably attached to the door adjacent to a longitudinal side of the door such that the pins may be extended past the longitudinal side to lock the door and retracted behind the longitudinal side to unlock the door;
an outer handle operatively coupled to the deadbolt bar through an outer shaft;
a lock for releasably engaging the deadbolt bar to prevent movement of the deadbolt bar;
a control means for controlling when the lock engages the deadbolt bar and when the lock releases the deadbolt bar;
a hinge mounted on a peripheral edge of the door for connecting the door to a door frame, the hinge being rotatable 180 degrees in only one direction; and
a security bar to prevent the door from being pulled open, the security bar being mounted along the peripheral edge of the door where the hinge is mounted and at a distance from the hinge such that the security bar overlaps the door frame when the door is closed.

17. The security door of claim 16, further comprising an inner handle operatively coupled to the deadbolt bar through an inner shaft.

18. The security door of claim 17, further comprising
a stabilizer for stabilizing the inner shaft, the stabilizer comprising a nut having an internal screw thread and being mounted on the interior surface of the door, and the inner shaft has an external screw thread, the external screw thread of the inner shaft being rotatably engaged to the internal screw thread of the stabilizer.

19. The security door of claim 16, wherein the control means is positioned on the outer side of the door such that the control means can be operated only from the outside of the door.

20. The security door of claim 16, wherein the control means controls the lock remotely.

21. The security door of claim 20, wherein the control means is a remote keypad.

22. The security door of claim 16, wherein the control means comprises: an outer control means positioned outside the door and an inner control means positioned inside the door such that the control means can be operated from the inside and the outside of the door.

23. The security door of claim 22, wherein the inner control means is the inner handle.

24. The security door of claim 22, wherein the inner control means comprises a second inner handle mounted on the interior surface of the door.

25. The security door of claim 16, wherein the door comprises an inner door pan and an outer door pan.

26. The security door of claim 25, wherein deadbolt bar is mounted between the inner door pan and the outer door pan.

27. A security door comprising:
a door;
a deadbolt assembly comprising: a retractable multiple pin deadbolt bar mounted on the door, the deadbolt bar having an extended position locking the door and a retracted position unlocking the door;
an outer handle assembly operatively coupled to the deadbolt assembly;
an inner handle assembly operatively coupled to the deadbolt assembly;
a lock for releasably engaging the deadbolt bar to prevent movement of the deadbolt bar;
a control means for controlling when the lock engages the deadbolt bar and when the lock releases the deadbolt bar;
an hinge mounted on a peripheral edge of the door for connecting the door to a door frame, the hinge being rotatable 180 degrees in only one direction; and
a security bar for preventing the door from being pulled open, the security bar being mounted along the peripheral edge of the door where the hinge is mounted and at a distance from the hinge such that the security bar overlaps the door frame when the door is closed.

28. The security door of claim 27, wherein
the deadbolt bar has a generally vertically disposed bar slot;
the outer handle assembly comprises: an outer shaft rotatably mounted on an exterior surface of the door, the outer shaft extending from the exterior surface through an interior surface of the door; an outer handle attached to the exterior end of the outer shaft; an outer plate attached to the distal end of the outer shaft parallel to the interior surface of the door such that the outer plate rotates around the axis of the outer shaft; an outer pin attached to the distal end of the outer plate, the outer pin extending through the bar slot and disposed to coact with the bar slot such that a clockwise rotational movement of the outer handle rotates the outer plate to move the outer pin downwards to move the deadbolt bar inwards to retract the deadbolt bar and a counter-clockwise rotational movement of the outer handle rotates the outer plate upwards to move the outer pin upwards to move the deadbolt bar outwards to extend the deadbolt bar.

29. The security door of claim 27, wherein
the deadbolt assembly further comprises a generally horizontally disposed gag plate attached to the deadbolt bar, the gag plate having a generally rectangular inner assembly opening, a generally horizontal inner handle slot disposed below the inner assembly opening and a flange disposed on top of the gag plate, the flange having a generally rectangular aperture;
the inner handle assembly further comprises: a stabilizer mounted on an interior surface of the door; an inner shaft having an external screw thread at one end, the inner shaft extending through the inner handle slot and the external screw thread being rotatably engaged to the stabilizer; an inner handle attached to the distal end of the inner shaft; an inner plate attached to the inner shaft parallel to the interior surface of the door at a distance from the external screw thread and above the gag plate such that the inner plate rotates around the axis of the inner shaft; an inner pin attached to the distal end of the inner plate, the inner pin extending through the inner assembly opening and disposed to coact with the inner assembly opening such that a counter-clockwise rotational movement of the inner handle rotates the inner plate inwards to move the inner pin inwards to move the gag plate inwards to retract the deadbolt bar and a clockwise rotational motion of the outer handle rotates the inner plate outwards to move the inner pin outwards to move the gag plate outwards to extend the deadbolt bar; and
the lock has a generally horizontal tongue, the lock being disposed above the gag plate such that the tongue extends into the aperture when the lock is in the locked position and is retracted from the aperture when he lock is in the unlocked position.

30. The security door of claim 29, wherein
the inner handle is rotatable in a counter-clockwise direction to rotate the distal end of the inner plate inwards to engage the tongue when the tongue is in the extended position to move the tongue upwards and out of the aperture.

31. The security door of claim 29, further comprising a second inner handle assembly comprising: a second inner shaft rotatably mounted to the interior surface of the door; a second inner handle mounted on the distal end of the second inner shaft; an second inner plate attached to the inner shaft parallel to the interior surface of the door, the second inner handle being rotatable in a counter-clockwise direction to rotate the distal end of the second inner plate inwards to engage the tongue when the tongue is in the extended position to move the tongue upwards and out of the aperture.

32. The security door of claim 27, wherein the control means is positioned on the outer side of the door such that the control means can be operated only from the outside of the door.

33. The security door of claim 27, wherein the control means is a remote keypad.

34. The security door of claim 27, wherein the security bar comprises a longitudinal metal bar having an L-shaped cross-section.
